(19) United States
(12) Patent Application Publication
(10) Pub. No.: US 2026/0056081 A1
(43) Pub. Date: Feb. 26, 2026

(54) Ultra-High Purity Gas Cylinder Leak Detection Systems and/or Methods

(71) Applicant: ELECTRONIC FLUOROCARBONS, LLC, Hopkinton, MA (US)

(72) Inventors: Adam J. Seymour, Northglenn, CO (US); Curtis Wayne Marler, Linwood, NJ (US); Andrew Tritsch, Horsham, PA (US)

(73) Assignee: ELECTRONIC FLUOROCARBONS, LLC, Hopkinton, MA (US)

(21) Appl. No.: 19/105,796

(22) PCT Filed: Aug. 25, 2023
(86) PCT No.: PCT/US2023/031151

§ 371 Date: Feb. 22, 2025

Related U.S. Application Data
(60) Provisional application No. 63/400,851, filed on Aug. 25, 2022.

(51) Int. Cl. G01M 3/20

(52) U.S. Cl. CPC G01M 3/20

(57) ABSTRACT

Systems for detecting gas leaks in gas systems are provided. The systems can include: at least one gas cylinder; at least one valve assembly operatively engaged with the gas cylinder; and a purge conduit assembly operatively engaged with an interior portion of the valve assembly. Methods for detecting gas cylinder leaks in a gas system are provided. The methods can include providing purge gas through an interior portion of a valve assembly operably coupled to a gas cylinder. The system is enclosed within a cabinet; the method can include providing positive pressure within the cabinet sufficient to provide flow through the purge conduit assembly. Ultra-high purity gas cylinder valve assemblies are provided. The assemblies can include: a diaphragm separating an upper and lower portion of the valve assembly; a purge gas input conduit in fluid communication with the upper portion; and a purge gas outlet conduit in fluid communication with the upper portion.

### CLAIM FOR PRIORITY

This application claims priority to U.S. Provisional Patent Application Ser. No. 63/400,851 filed Aug. 25, 2022, entitled “Ultra-High Purity Gas Cylinder Leak Detection Systems and/or Methods”, the entirety of which is hereby incorporated by reference.

### TECHNICAL FIELD

The present disclosure relates to detecting leaks in gas systems, particularly ultra-high purity (UHP) gas systems.

### BACKGROUND

Hazardous and corrosive gasses are broadly used in different fabrications, and in these fabrications when gasses are lost via leaks, it can be quite expensive for the manufacturer in terms of lost materials and damage to gas delivery systems. Current technology and gas sensors commonly available in UHP gas cabinets in semiconductor fabrication and other applications to detect the leaks use high face velocity suction ventilation systems to safely draw and abate any toxic gas leaks that may occur from the panel, valves, or gas connections. The downside to the high flow regime is many leaks and failures occur as a slow, low concentration event that are diluted by the high face velocity to below the detection limits of gas sensors. These material leaks often continue to evolve without notice until catastrophic levels of material leakage have occurred causing significant damage to the cabinets and unknown periods of possible quality issues with delivered materials that have now been in possible contact with the atmosphere. What is needed is a method or system that can detect leaks in systems sooner rather than later. The present disclosure provides such systems and methods.

### SUMMARY

Accordingly, systems for detecting gas leaks in gas systems are provided. The systems can include: at least one gas cylinder; at least one valve assembly operatively engaged with the at least one gas cylinder; and a purge conduit assembly operatively engaged with an interior portion of the at least one valve assembly.

Methods for detecting gas cylinder leaks in a gas system are also provided. The methods can include providing purge gas through an interior portion of a valve assembly operably coupled to a gas cylinder. The system is enclosed within a cabinet and the method can include providing positive pressure within the cabinet sufficient to provide flow through the purge conduit assembly.

Ultra-high purity gas cylinder valve assemblies are also provided. The assemblies can include: a diaphragm separating an upper and lower portion of the valve assembly; a purge gas input conduit in fluid communication with the upper portion; and a purge gas outlet conduit in fluid communication with the upper portion.

### DRAWINGS

Embodiments of the disclosure are described below with reference to the following accompanying drawings.

FIG. 1A is a cutaway of a regulator assembly according to an embodiment of the disclosure.

FIG. 1B is a view of a portion of a regulator assembly according to an embodiment of the disclosure.

FIG. 1C is another view of a regulator assembly according to an embodiment of the disclosure.

FIG. 2 is a broader cutaway version of a regulator assembly according to an embodiment of the disclosure.

FIGS. 3A and 3B are views of regulator system assemblies according to an embodiment of the disclosure.

FIG. 4 is a view of a regulator system assembly according to an embodiment of the disclosure.

### DESCRIPTION

It has been realized that upper diaphragms in Ultra High Purity (UHP) gas cylinder valves can and do fail to prevent leaks. The systems and/or methods of the present disclosure can utilize engineered portions of common valves in semiconductor gas service to allow a designed purge rate through above the non-wetted side of the upper diaphragm applying positive pressure using N2, He, Ar, Air, and/or other inert gas or a pulled flow using a pump and fixed orifice pushing the contents of the gas over already existing integrated gas sensors allowing for as much as >100× increase in sensitivity and time response to a failure of the sealing mechanism. Cabinets and/or ventilation hoods can be modified with little cost and can greatly increase the safety factor and decrease response time in an incident.

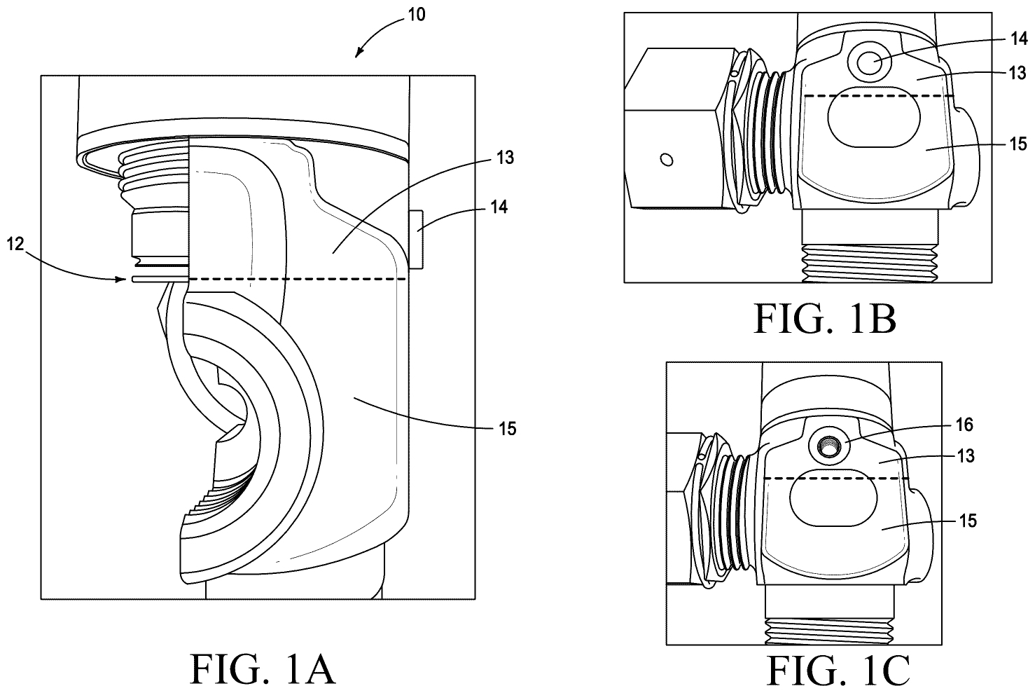

The present disclosure will be described with reference to FIGS. 1A-4. Referring first to FIG. 1A, an example regulator 10 is shown that depicts a diaphragm 12 and also a leak port 14. Leak port 14 is shown in a closed or sealed position in FIG. 1B, and in an open position 16 as depicted in FIG. 1C. It has been discovered that at the first sign of a leak, the diaphragm 12 is the most likely culprit for the leak. Thus, a leak will exit through the open diaphragm or out to the leak port 14. However, in most cases, leak port 14 is closed, and the leak will exit the regulator assembly to a cabinet or the surrounding atmosphere, which is typically enclosed by a cabinet. It has been realized that the large amount of space needs to be substantially occupied before a leak detector within that space can detect a leak.

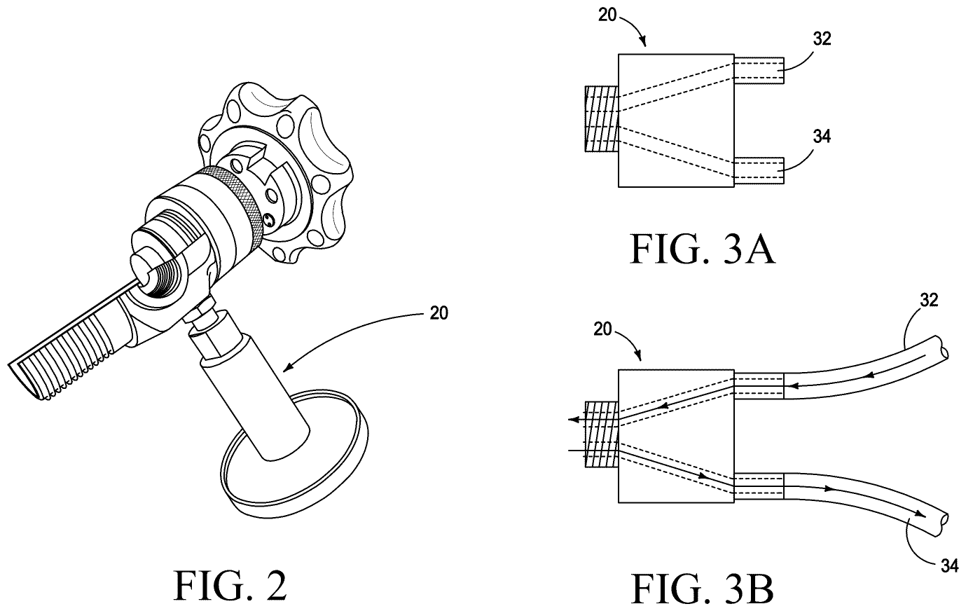

The present disclosure provides an additional assembly shown in FIG. 2 that can be coupled to the regulator assembly and provide a coupling for at least two additional conduits that can be configured to provide sweep gas past the regulator and to a detection assembly. The fitting can be configured to utilize an M4 connection on a Rotarex or other branded valve into the leak port. The M4 fitting will have an inlet and outlet port which can be precision laser drilled to create a fixed size orifice for a controlled flow. Two modes of operation can be provided, first a positive pressure with the Z-purge gas on the cabinet can be used in conjunction with a fixed orifice on the fitting to create a designed purge rate optimal to that of the gas sensor and possible leak rate. The connection to the gas sensor will be through a poly or steel tube. Alternatively, the gas sensor can use an onboard pump to draw atmosphere through the orifice fitting at a rate optimal to that of the sensor. This embodiment may be preferred when the cylinders are in a ventilation hood.

An example configuration is shown in FIG. 3A with sweep gas entrance 32 and sweep gas return 34 as part of assembly 20. Assembly 20 is shown in more detail with the sweep gas entering and returning as shown in FIG. 3B. In accordance with example implementations, this gas can be air or any other gas, but the gas, upon its return from traversing the regulator, can be sent to a detection assembly where any slight detection of ultra-high purity gas can be detected, thus alleviating the loss of gas in detecting a leak sooner rather than later.

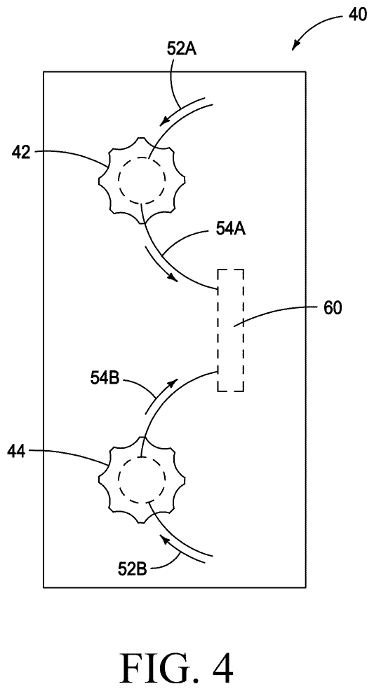

In accordance with example configurations, these ultra-high purity gasses can be contained in cabinets as shown in FIG. 4. Cabinet 40 can include at least two tanks that have two regulator assemblies, 42 and 44. Within each regulator assembly can be individual conduits, for example, 52A and 54A. Regulator 42 can be associated with conduits 52A and 54A, and regulator 44 can be operably engaged with conduits 52B and 54B. Both 54A and 54B can be operably coupled to a manifold or detection assembly 60. As a manifold, it can be plumbed to a single line that is operably engaged with a detection assembly not shown. In accordance with example implementations, leak detection for these ultra-high purity gasses can be directly connected to the regulators, and thus significantly limit the amount of lost gas by detecting leaks almost instantaneously. In accordance with other implementations, these assemblies and configurations can be operably engaged with alarms and/or auto shutoffs as desired.

Accordingly, systems for detecting gas leaks in gas systems are provided. The systems can include: at least one gas cylinder; at least one valve assembly operatively engaged with the at least one gas cylinder; and a purge conduit assembly operatively engaged with an interior portion of the at least one valve assembly.

The system can be enclosed within a cabinet. The systems can include at least one gas sensor assembly operatively aligned with the purge conduit assembly. The gas sensor assembly can include a pump configured to provide negative pressure to the purge conduit assembly. The systems can include a purge gas source. The purge gas of the purge gas source is one or more of air, N₂, He, and/or Ar.

The system can also include a plurality of gas cylinders. Individual ones or each of the plurality of gas cylinders can be operatively engaged with the at least one valve assembly. Each of the plurality of gas cylinders can be operatively engaged with a plurality of valve assemblies.

Methods for detecting gas cylinder leaks in a gas system are also provided. The methods can include providing purge gas through an interior portion of a valve assembly operably coupled to a gas cylinder. The system is enclosed within a cabinet and the method can include providing positive pressure within the cabinet sufficient to provide flow through the purge conduit assembly.

The purge gas can be provided through the interior portion of the valve assembly by providing negative pressure to the interior portion to the valve assembly; for example, providing a vacuum operatively coupled to the outlet port of the valve assembly. In accordance with other implementations, purge gas can be received from the interior portion of the valve assembly and analyzing the purge gas received for one or more gases housed in the system.

Additionally, the purge gas can be provided through an interior portion of a plurality of valve assemblies, which may be aligned in series.

Ultra-high purity gas cylinder valve assemblies are also provided. The assemblies can include: a diaphragm separating an upper portion 13 and lower portion 15 of the valve assembly; a purge gas input conduit in fluid communication with the upper portion 13; and a purge gas outlet conduit in fluid communication with the upper portion 13. The valve assembly can include a leak port. The leak port of the valve assembly can be operatively engaged with both the purge gas input and the purge gas outlet. The valve assembly can also include a manifold operatively engaged with the input and output of the assembly. The manifold can be operatively engaged with a plurality of gas cylinders.

1: A system for detecting gas leaks in gas systems, the system comprising:
at least one gas cylinder;
at least one valve assembly operatively engaged with the at least one gas cylinder; and
a purge conduit assembly operatively engaged with an interior portion of the at least one valve assembly.

2: The system of claim 1 wherein the system is enclosed within a cabinet.

3: The system of claim 1 further comprising at least one gas sensor assembly operatively aligned with the purge conduit assembly.

4: The system of claim 3 wherein the gas sensor assembly comprises a pump configured to provide negative pressure to the purge conduit assembly.

5: The system of claim 1 further comprising a purge gas source.

6: The system of claim 5 wherein a purge gas of the purge gas source is one or more of air, N2, He, and/or Ar.

7: The system of claim 1 further comprising a plurality of gas cylinders.

8: The system of claim 7 wherein each of the plurality of gas cylinders are operatively engaged with the at least one valve assembly.

9: The system of claim 7 wherein each of the plurality of gas cylinders are operatively engaged with a plurality of valve assemblies.

10: A method for detecting gas cylinder leaks in a gas system, the method comprising providing purge gas through an interior portion of a valve assembly operably coupled to a gas cylinder.

11: The method of claim 10 wherein the system is enclosed within a cabinet.

12: The method of claim 11 further comprising providing positive pressure within the cabinet sufficient to provide flow through the purge conduit assembly.

13: The method of claim 10 wherein the providing the purge gas through the interior portion of the valve assembly comprises providing negative pressure to the interior portion of the valve assembly.

14: The method of claim 13 further comprising providing receiving purge gas from the interior portion of the valve assembly and analyzing the purge gas received for one or more gases housed in the system.

15: The method of claim 10 further comprising providing the purge gas through an interior portion of a plurality of valve assemblies.

16: The method of claim 15 wherein the plurality of valve assemblies are aligned in series.

17: An ultra-high purity gas cylinder valve assembly, the assembly comprising:
a diaphragm separating an upper and lower portion of the valve assembly;
a purge gas input conduit in fluid communication with the upper portion; and
a purge gas outlet conduit in fluid communication with the upper portion.

18: The valve assembly of claim 17 wherein the valve assembly comprises a leak port.

19: The valve assembly of claim 18 wherein the leak port of the valve assembly is operatively engaged with both the purge gas input and the purge gas outlet.

20: The valve assembly of claim 17 further comprising a manifold operatively engaged with the input and output of the assembly.

21: The valve assembly of claim 18 wherein the manifold is operatively engaged with a plurality of gas cylinders.
